(19) United States
(12) Patent Application Publication
(10) Pub. No.: US 2022/0411686 A1
(43) Pub. Date: Dec. 29, 2022

(54) PARTICULATE SLURRIES AND METHODS OF MAKING THE SAME

(71) Applicant: 3M INNOVATIVE PROPERTIES COMPANY, St. Paul, MN (US)

(72) Inventors: Ana MARTINEZ SAENZ DE JUBERA, Madison, CT (US); Majid ENTEZARIAN, Glastonbury, CT (US); Robert GIEGER, Guilford, CT (US); Qilin CHAN, Woodbury, MN (US)

(21) Appl. No.: 17/776,692

(22) PCT Filed: Nov. 25, 2020
(86) PCT No.: PCT/IB2020/061151

§ 371 Date: May 13, 2022

Related U.S. Application Data
(60) Provisional application No. 62/943,527, filed on Dec. 4, 2019.

(51) Int. Cl. C09K 3/14; B24B 57/02; B01D 69/08; B01D 71/68; B01D 69/10; B01D 61/14; B01D 69/02

(52) U.S. Cl. CPC C09K 3/1409; B24B 57/02; B01D 69/08; B01D 71/68; B01D 69/10; B01D 61/147; B01D 69/02; B01D 2325/36; B01D 2325/38; B01D 2311/2523

(57) ABSTRACT

The present disclosure provides a method of making a chemical mechanical planarization slurry. The method includes contacting a chemical mechanical planarization slurry precursor including a carrier and a plurality of abrasive particles with a semi-permeable fiber membrane. Upon contact, the method further includes separating the chemical mechanical planarization slurry precursor into a concentrate and an effluent. The concentrate includes the chemical mechanical planarization slurry and the effluent includes the carrier and a plurality of particles. The particles of the effluent have a median size that is less than a median size of the abrasive particles of the concentrate. In the method a pressure difference measured between an inlet to which the chemical mechanical planarization slurry precursor is supplied and a first outlet to which the effluent is supplied is in a range of from about 1 psi to about 15 psi.

### BACKGROUND

Particulate slurries such as chemical mechanical planarization slurries can be used for the fabrication of electronic components. However, the effectiveness of various chemical planarization slurries can be impacted by the size of the abrasive particles in the slurry. It is therefore desirable to develop chemical mechanical planarization slurries as well as methods and systems for making them that include abrasive particles having a desired size.

### SUMMARY OF THE DISCLOSURE

The present disclosure provides a method of making a chemical mechanical planarization (CMP) slurry. The method includes contacting a chemical mechanical planarization slurry precursor including a carrier and a plurality of abrasive particles with a semi-permeable fiber membrane. Upon contact, the method further includes separating the chemical mechanical planarization slurry precursor into a concentrate and an effluent. The concentrate includes the chemical mechanical planarization slurry and the effluent includes the carrier and a plurality of particles. The particles of the effluent have a median size that is less than a median size of the abrasive particles of the concentrate. In the method, a pressure difference measured between an inlet to which the chemical mechanical planarization slurry precursor is supplied and a first outlet to which the effluent is supplied is in a range of from about 1 psi to about 15 psi.

The present disclosure further provides a system for producing a chemical mechanical planarization slurry. The system includes a semi-permeable fiber membrane. The system further includes a chemical mechanical planarization slurry precursor in contact with the semi-permeable fiber membrane. The chemical mechanical planarization precursor slurry includes a carrier and a plurality of abrasive particles. The system further includes a case that at least partially contains the semi-permeable fiber membrane. The case includes an inlet feeding into the case, a first outlet, and a second outlet. The system further includes a recirculation line attached to the second outlet and in fluid communication with the inlet. The system is configured to create a pressure difference measured between the inlet and the first outlet in a range of from about 1 psi to about 15 psi.

The present disclosure further provides a particulate slurry. The particulate slurry includes a carrier. The particulate slurry further provides a plurality of abrasive particles disposed in the carrier. The plurality of abrasive particles have a size distribution curve substantially conforming to a negatively skewed distribution curve relative to a normal distribution curve. A majority of the abrasive particles have a median size of at least 20 nm.

The present disclosure further provides a particulate slurry. The particulate slurry includes a carrier. The particulate slurry further provides a plurality of abrasive particles disposed in the carrier. The plurality of abrasive particles have a size distribution curve substantially conforming to a negatively skewed distribution curve relative to a normal distribution curve. A majority of the abrasive particles have a median size of less than at least 30 nm.

### BRIEF DESCRIPTION OF THE FIGURES

The drawings illustrate generally, by way of example, but not by way of limitation, various embodiments discussed in the present document.

FIG. 1 is a schematic view of a system for producing a chemical mechanical planarization slurry, in accordance with various embodiments.

FIG. 2 is a graph showing the particle size distribution of the slurry collected in Example 1, in accordance with various embodiments.

FIG. 3 is a graph showing the particle size distribution of the slurry collected in Example 2, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

According to various embodiments of the present disclosure, a chemical mechanical planarization slurry, method for making a chemical mechanical planarization slurry, and a system for performing a method for making a chemical mechanical planarization slurry are described. Although chemical mechanical planarization slurries are described herein, it is understood that the teachings can equally apply to other types of particulate slurries. Chemical mechanical planarization slurries are used in a chemical mechanical polishing or planarization processes for the fabrication of microelectronics. According to various embodiments, a chemical mechanical planarization or polishing process uses an abrasive and corrosive chemical mechanical planarization slurry in conjunction with a polishing pad and retaining ring, that can have a greater diameter than a wafer that is being polished. The pad and wafer, for example, can be pressed together by a dynamic polishing head and held in place by a plastic retaining ring. The dynamic polishing head can be rotated with different axes of rotation (e.g., not concentric). This removes material and tends to even out any irregular topography, making the wafer flat or planar. This may be necessary to set up the wafer for the formation of various circuit elements.

One parameter that can be controlled to increase the effectiveness of the process is to carefully control the size of the abrasive particles in the chemical mechanical planarization slurry. This is because abrasive particles that are too small (e.g., with a major dimension less than 50 nm, 40 nm, 30 nm, 20 nm, or 10 nm) can actually be a contaminate that can block features formed in the resulting microelectronic or can fuse together. It can therefore be advantageous, according to various embodiments, to develop systems and methods for producing chemical mechanical planarization slurries in which a majority of the abrasive particles are large enough to not lead to the aforementioned drawbacks.

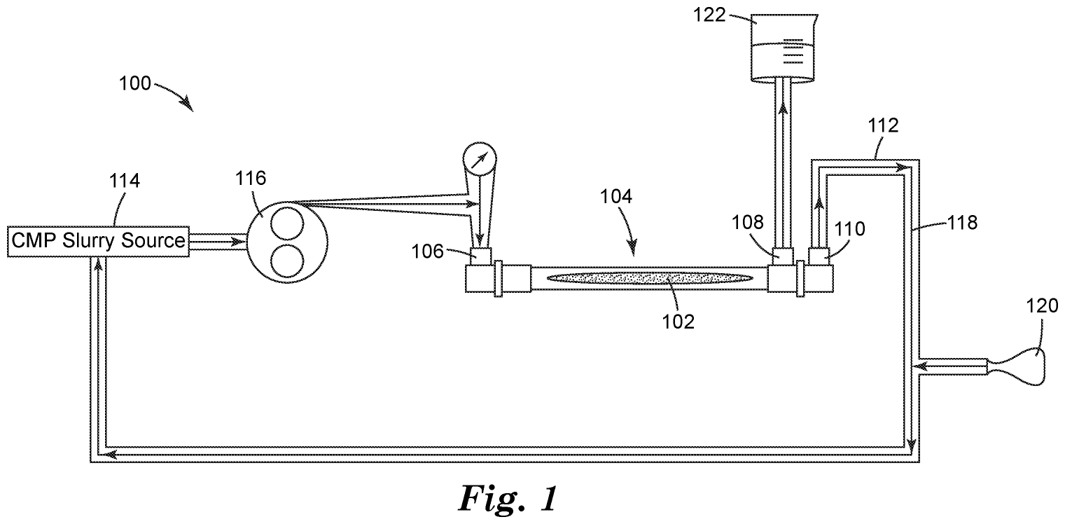

FIG. 1 is a schematic partial sectional diagram showing system 100. System 100 includes semi-permeable fiber membrane 102. Semi-permeable fiber membrane 102 is at least partially contained by case 104. Case 104 can include a plastic or metal material and is shown as a partial sectional view. Case 104 includes inlet 106, which feeds into case 104 and also includes first outlet 108 and second outlet 110. System 100 also includes recirculation line 112, which is attached to second outlet 110 and is in fluid communication with inlet 106. System 100 further includes chemical mechanical planarization slurry precursor 114. System 100 further includes supplemental solution source 120, which can add components such as electrolytes, surfactants or the like to recirculation line 112. System 100 further includes collection vessel 122 in fluid communication with first outlet 108.

Semi-permeable fiber membrane 102 includes at least one fiber. According to various embodiments, semi-permeable fiber membrane 102 can include more than one fiber. For example, semi-permeable fiber membrane 102 can include about 2 fibers to about 100,000 fibers, about 10 fibers to about 10,000 fibers, about 50 fibers to about 1,000 fibers, at least 2 fibers, at least 3 fibers, at least 4 fibers, at least 5 fibers, at least 10 fibers, at least 20 fibers, at least 30 fibers, at least 40 fibers, at least 50 fibers, at least 100 fibers, at least 500 fibers, at least 1,000 fibers, at least 5,000 fibers, at least 10,000 fibers, at least 20,000 fibers, at least 40,000 fibers, at least 60,000 fibers, at least 80,000 fibers, or at least 100,000 fibers.

Fibers can be hollow fibers or non-hollow fibers. In embodiments where semi-permeable fiber membrane 102 includes a plurality of fibers, all fibers can be hollow or non-hollow. Alternatively, there can be mixtures of fibers in which at least a portion of the total number of fibers are hollow while another portion of the total number of fibers are non-hollow. In these embodiments, each portion can independently range from about 5 percent of the total amount of fibers to about 95 percent of the total amount of fibers, about 20 percent to about 70 percent, about 30 percent to about 50 percent, or about 30 percent to about 40 percent.

At least some of fibers can have a substantially cylindrical shape. The substantially cylindrical shape can be characterized dimensionally by their major diameter, major length, or both. A major length of fibers can independently be in a range of from about 10 cm to about 300 cm from about 30 cm to about 200 cm, or about 50 cm to about 100 cm. A major diameter of fibers can independently be in a range of from about 0.0005 mm to about 5 mm, about 0.001 mm to about 2.5 mm, about 0.005 mm to about 1.5 mm, about 0.01 mm to about 1 mm, or about 0.05 mm to about 0.5 mm. The major diameter can refer to a distance measured between two points on the outer surface of fiber. Alternatively, in embodiments in which fibers are hollow fibers, the major diameter can refer to an inner diameter of fibers measured between two points on the inner surface.

Individual fibers, e.g. hollow fibers, of semi-permeable fiber membrane 102 can include any one material or combination of materials. For example, individual fibers can include a hydrophobic aromatic sulfone polymer and at least one hydrophilic polymer. A cross section of the semi-permeable fiber membrane 102 may have a three-layer, annular shaped structure including a support layer disposed between a protection layer, located at the exterior of the semi-permeable fiber membrane, and a separation layer, located at the interior of the semi-permeable fiber membrane. The protection layer includes an exterior surface and the separation layer includes an interior surface. The semi-permeable fiber membrane has a thickness and includes an open pore structure between the interior surface of the separation layer and the exterior surface of the protection layer, i.e. through the thickness of the semi-permeable fiber membrane. The separation layer is adjacent the semi-permeable fiber membrane lumen. A fluid containing a liquid and particles having a particle size distribution, e.g. a chemical mechanical planarization slurry precursor, is capable of flowing through the lumen, along the length of the semi-permeable fiber membrane. The open pore structure permeating through the thickness of the semi-permeable fiber membrane allows a portion of the liquid and particles in the low end of the particle size distribution, e.g. the smallest particles of the distribution, to flow from the interior surface, through the thickness, and out the exterior surface of the semi-permeable fiber membrane. Larger particles of the distribution along with the remaining liquid flow through the lumen along the length of the semi-permeable fiber membrane and are separated from the smaller particles that have been transported through the thickness of the semi-permeable fiber membrane. Semi-permeable fiber membranes are known, for example, see U.S. Pat. Nos. 3,228,877; 3,755,034; 4,220,535; 4,940,617; 5,186,832; 5,264,171; 5,284,584; 5,449,457, each is incorporated herein by reference.

The separating layer can be configured to have a cutoff for particles by their mass. For example, the separating layer can have a cutoff in the range between 2,000 and 200,000 Daltons, about 5,000 Daltons to about 100,000 Daltons, about 30,000 Daltons to about 50,000 Daltons. A pore structure in the separating layer can be configured to have a gradient such that the average size of the pores in the supporting layer initially increases from the separating layer up to a zone with maximum pore size, then decreases beyond this zone towards the outer layer. Alternatively, the pore size can be substantially the same such that the separating layer is free of a gradient. The average pore size can be in a range of from 5 μm to about 100 μm, 10 μm to about 80 μm, or 10 μm to about 50 μm. At least a portion of the pores can be through pores. A total porosity of semi-permeable fiber membrane 102 can be in a range of from about 55 vol % to about 95 vol %, 60 vol % to about 90 vol %, or about 70 vol % to about 85 vol %, A wall thickness of the semi-permeable fiber membrane 102 can be in a range from about 100 μm to 450 μm, about 1500 μm to about 375 μm or about 200 μm to about 300 μm.

Semi-permeable fiber membrane 102 can be produced from a homogeneous spinning solution of the polymer component and a solvent system. The polymer component can include a hydrophobic aromatic sulfone polymer and at least one hydrophilic polymer. A concentration of the sulfone polymer in the spinning solution can be in a range of from about 17 wt % to about 27 wt % or about 20 wt % to about 25 wt %. The spinning solution can further include about 20 wt % to about 25 wt % of the hydrophobic aromatic sulfone polymer or about 23 wt % Vo to about 24 wt %. The sulfone polymer can also include additives such as antioxidants, nucleating agents, UV absorbers, etc to selectively modify the properties of the membranes

Suitable hydrophobic aromatic sulfone polymers from which the semi-permeable fiber membrane 102 can include according to various embodiments are polysulfone, polyether sulfone, polyphenylene sulfone or polyaryl ether sulfone. According to various embodiments, the hydrophobic aromatic sulfone polymer can be a polysulfone or a polyether sulfone with the repeating molecular units shown in the following formulae (I) and (II):

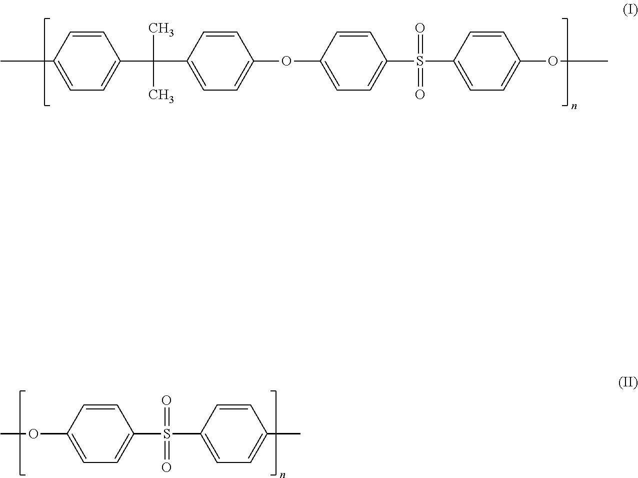

Long-chain polymers can be used as the at least one hydrophilic polymer that on the one hand exhibit a compatibility with the hydrophobic aromatic sulfone polymer and have repeating polymer units that in themselves are hydrophilic. A suitable hydrophilic polymer can be one with a mean molecular weight Mw of at least 10,000 Daltons. The hydrophilic polymer can be poly-vinylpyrrolidone, polyethylene glycol, polyvinyl alcohol, polyglycol monoester, a polysorbitate such as polyoxyethylene sorbitan monooleate, carboxymethyl-cellulose or a modification or copolymer of these polymers. Polyvinylpyrrolidone and polyethylene glycol are suitable examples.

According to various embodiments, the at least one hydrophilic polymer can also include mixtures of different hydrophilic polymers. The hydrophilic polymer can, for example, be a mixture of chemically different hydrophilic polymers or of hydrophilic polymers with different molecular weights, e.g. a mixture of polymers whose molecular weight differs by a factor of 5 or more. According to various embodiments, the at least one hydrophilic polymer comprises a mixture of polyvinylpyrrolidone or polyethylene glycol with a hydrophilically modified aromatic sulfone polymer. According to various embodiments, the hydrophilically modified aromatic sulfone polymer can be a sulfonated aromatic sulfone polymer, in particular a sulfonated modification of the hydrophobic aromatic sulfone polymer employed in the membrane according to various embodiments and in the method. Mixtures of polyether sulfone, sulfonated polyether sulfone and polyvinylpyrrolidone can be employed for the semi-permeable fiber membrane 102 according to various embodiments. As a result of the presence of a hydrophilically modified aromatic sulfone polymer, semi-permeable fiber membrane 102 with particularly stable hydrophilic properties in the application are obtained.

System 100 is configured to ensure that a pressure drop between inlet 106 and first outlet 108 can be minimalized. This pressure drop can be accomplished by configuring inlet 106 and first outlet 108 in a variety of ways. For example, first outlet 108 can be configured to be substantially the same size as inlet 106. For example, this can mean that the major diameter of first outlet 108 can be substantially the same as that of inlet 106. In further embodiments, first outlet 108 can be free of a restriction device (e.g., a valve) such that the flow from first outlet 108 is substantially unimpeded. In embodiments where there is a restriction device affixed to first outlet 108, the device may not be engaged such that first outlet 108 is essentially unrestricted. Configuration of first outlet 108 in this manner can help to create a pressure difference, measured between inlet 106 and first outlet 108, in a range of from about 1 psi to about 15 psi, about 3 psi to about 13 psi or about 5 psi to about 10 psi.

Chemical mechanical planarization slurry precursor 114 located in system 100 can be driven through pump 116. Pump 116 is shown as positioned upstream of inlet 106. However, in further embodiments, pump 116 can be located at any other suitable location. For example, pump 116 can be located downstream of first outlet 108 or second outlet 110. Recirculation line 112 can be used to supply a solution between second outlet 110 and inlet 106.

Chemical mechanical planarization slurry 118 produced by system 100 can be characterized by its constituents. For example, chemical mechanical planarization slurry 118 can include a carrier and a plurality of abrasive particles. The carrier can include an aqueous solution or an organic solution. In embodiments in which the carrier is an aqueous solution, the carrier can include from about 55 wt % to about 100 wt % water, from about 70 wt % to about 100 wt % water or from about 90 wt % to about 100 wt % water. Furthermore, in embodiments in which the carrier is an organic solution, the carrier can include from about 55 wt % to about 100 wt % substituted or unsubstituted (C₁-C₂₀)hydrocarbyl, about 90 wt % to about 100 wt % substituted or unsubstituted (C₁-C₂₀)hydrocarbyl, less than, equal to, or greater than about 55 wt %, 60, 65, 70, 75, 80, 85, 90, 95, or about 100 wt % substituted or unsubstituted (C₁-C₂₀)hydrocarbyl.

The abrasive particles of chemical mechanical planarization slurry 118 can be formed from any suitable material. For example, the abrasive particles can include an inorganic material, an organic material, or a mixture thereof. In examples in which the abrasive particles include an inorganic material, the inorganic material can include an elemental metal, a metal alloy, a metal oxide, a ceramic, or a mixture thereof. Examples of ceramic materials can include alumina, silica, ceria, a silicon nitride, a glass, an alumina-phosphorous pentoxide, an alumina-boria-silica, a zirconia, a zirconia-alumina, a zirconia-silica, an aluminum oxide, a heat-treated aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Where the abrasive particles include an organic material, the abrasive particles can be characterized as comparatively “soft” abrasive particles. The soft abrasive particles described herein can include any suitable material or combination of materials. For example, the soft abrasive particles can include a reaction product of a polymerizable mixture including one or more polymerizable resins. The one or more polymerizable resins can be chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

The abrasive particles described herein can substantially conform to any suitable morphology. The individual morphology of the abrasive particles can be such that an aspect ratio of the abrasive particles is in a range of from about 1.0 to about 5.0, from about 1.0 to about 3.0, from about 1.0 to about 2.0 or from about 1.0 to about 1.5. Examples of suitable shapes for the abrasive particles can include those having a substantially spherical morphology. According to various embodiments, the abrasive particles can be formed to have a specifically controlled geometric shape and can be referred to as shaped abrasive particles, which are particles that include a replicated shape. The shape can be any suitable shape three-dimensional shape such as a pyramid, cone, block, cube, sphere, cylinder, rod, triangle, hexagon, square, and the like.

According to various embodiments, chemical mechanical planarization slurry 118 described herein can be formed according to many suitable methods. In some embodiments, chemical mechanical planarization slurry 118 can be formed using system 100.

A method of making chemical planarization slurry 118 using system 100, as an example, can include the steps of contacting chemical mechanical planarization slurry precursor 114 with semi-permeable fiber membrane 102. Chemical mechanical planarization slurry precursor 118 can be supplied through inlet 106 where it enters the interior of system 100 and is driven in to contact with semi-permeable fiber membrane 102. Chemical mechanical planarization slurry precursor 114 is similar in content to the final chemical mechanical planarization slurry 118 in that it includes the carrier and a plurality of abrasive particles. However, the chemical planarization slurry precursor 114 differs in composition in that it has a wider distribution of abrasive particles by size than chemical mechanical planarization slurry 118.

The difference in the size of the abrasive particles between chemical mechanical planarization slurry precursor 114 and of chemical mechanical planarization slurry 118 itself is accomplished by separating chemical mechanical planarization slurry precursor 114 into a concentrate and an effluent. Semi-permeable fiber membrane 102 is configured to allow only particles of a certain size to pass through. This portion leaves case 104 as an effluent through first outlet 108. The portion of chemical mechanical planarization slurry precursor 114 that cannot pass through semi-permeable fiber membrane 102 leaves case 104 through second outlet 110 as a concentrate that includes chemical mechanical planarization slurry 118. The result of the separation of chemical mechanical planarization slurry precursor 114 into a concentrate and an effluent leads to chemical mechanical planarization slurry 118 of the concentrate in which a median size of the abrasive particles therein is greater than a median size of the abrasive particles of the effluent. The respective sizes for the individual abrasive particles used to calculate the median size can be a major dimension of the individual abrasive particles. For reference, a median size of the abrasive particles found in the effluent can be less than or equal to about 30 nm, 25, 20, 15, 10, 5, or about 1 nm. Conversely, a median size of the abrasive particles of chemical mechanical planarization slurry 118 can be greater than or equal to about 1 nm, 5, 10, 15, 20, 25, 30, 35, 40, 45, 50, 55, 60, 65, 70, 75, 80, 85, 90, 95, 100, 105, 110, 115, 120, 125, 130, 135, 140, 145, or 150 nm.

In the chemical mechanical planarization slurry, the size distribution of the abrasive particles can be characterized as a non-gaussian distribution. For example, the chemical mechanical planarization slurry can have a left-skewed or negatively-skewed distribution. Conversely, the effluent can have a right-skewed or positively skewed distribution. As understood, a typical gaussian distribution is symmetrical and has two tails that are exactly the same. A skewed distribution, however, results from one of the tails being longer than the other. As understood, a left-skewed distribution has a long left tail. Left-skewed distributions are also called negatively-skewed distributions. That is because there is a long tail in the negative direction on the number line (e.g., x-axis). The mean is also to the left of the peak. As further understood, a right-skewed distribution has a long right tail. Right-skewed distributions are also called positive-skew distributions. That is because there is a long tail in the positive direction on the number line. The mean is also to the right of the peak.

To form chemical mechanical planarization slurry 118, a variety of the parameters of system 100 can be controlled. For example, as discussed above, it can be helpful to maintain a pressure difference between inlet 106 and first outlet 108 of about 1 psi to about 15 psi. The relatively low pressure difference can result in less of the abrasive particles having a size greater that the median size of the abrasive particles in the effluent, being forced into contact with semi-permeable fiber membrane 102 and therefore potentially clogging the pores of membrane 102. Another way to minimize or mitigate the risk of clogging is to control the flow rate at which chemical mechanical planarization slurry precursor 114 is pumped or vacuumed through an individual fiber of semi-permeable fiber membrane 102. According to various embodiments, this flow rate can be in a range of from about 0.5 ml/min to about 150 ml/min, from about 0.5 ml/min to about 100 ml/min, from about 0.5 ml/min to about 50 ml/min, from about 0.5 ml/min to about 25 ml/min, from about 0.5 ml/min to about 5 ml/min or from about 1.2 ml/min to about 2.3 ml/min. These rate values can be calculated on a per fiber basis or can be an aggregate measurement across all fibers or a plurality of fibers. In some embodiments, the above described flow rates may be the flow rate of chemical mechanical planarization slurry precursor 114 through inlet 106. The specific rate at which chemical mechanical planarization slurry 118 is vacuumed through fiber can be controlled by the pressure difference between inlet 106 and first outlet 108. Controlling the flow rate can also help to ensure an adequate and stable filtration capacity of system 100. Controlling the flow rate and pressure change can also be helpful to reduce the need to backwash semi-permeable fiber membrane 102 in order to remove nanoparticles clogging membrane 102.

According to various embodiments, a greater amount of chemical mechanical planarization slurry 118 is collected as chemical mechanical planarization slurry 118 as the concentrate than the amount of chemical mechanical planarization slurry precursor 114 captured as an effluent. According to various embodiments, the amount of chemical mechanical planarization slurry 118 is collected as the chemical mechanical planarization slurry 118 can be in a range of from about 5% to about 90% greater by weight than an amount of the chemical mechanical planarization slurry precursor 114 that exits as an effluent, about 25% to about 85% greater or about 50% to about 80% greater.

In order to collect further amounts of chemical mechanical planarization slurry 118 or to remove abrasive particles that are too small, the chemical mechanical planarization slurry 118 that is collected as a concentrate can be recirculated through system 100. Recirculation can be accomplished by driving chemical mechanical planarization slurry 118 from second outlet 110 through recirculation line 112 and back to inlet 106.

### EXAMPLES

Various embodiments of the present disclosure can be better understood by reference to the following Examples which are offered by way of illustration. The present disclosure is not limited to the Examples given herein.

### Examples

### Materials Used in the Examples

| Abbreviation | Description and Source |
|---|---|
| Colloidal silica | A Colloidal silica CMP Slurry having a silica mean |
| CMP Slurry 79 | sparticle ize of 79 nm, available from Dupont, Midland |
| | MI. |
| Colloidal silica | A Colloidal silica CMP Slurry having a silica mean |
| CMP Slurry 24 | particle size of 24 nm, available from Dupont, Midland |
| | MI. |
| Viton Tubing | A fluoroelastomer tubing, available under the trade |
| | designation Viton ™, available from Grainer, INC, |
| | Lake Forest IL. |

### Test Methods

### Elemental Analysis by Inductively Coupled Plasma Atomic Emission Spectrophotometer (ICP-AES)

The original CMP slurry, the effluent, and the retentive fluids were analyzed by ICP-AES. They were sonicated at room temperature for 5 minutes and mixed on a vortex for 1 minute before being sampled. The solutions were then diluted to 10 mL with MilliQ water (>18 MO cm). The dilution factors are 1000, by volume for the effluent of Example 1, 100 for the effluent of Example 2, and 100,000 for the original and retentive slurries. After being sonicated for 5 minutes, the diluted samples were analyzed by ICP-AES following the procedure below.

The instrument used for elemental analysis was a Perkin Elmer Optima 8300DV ICP-AES. The solutions were introduced into the ICP-AES through a perfluoroalkoxy (PFA) concentric nebulizer followed by a PFA Scott double pass spray chamber. The signal of axial view was recorded. The samples were analyzed against a four-point external calibration curve generated using solution standards containing 0, 0.2, 0.5, and 1 mg/L of silicon (Si). A 0.5-ppm quality control standard was used to monitor the accuracy of the calibration curve during the analysis. A 0.5-ppm solution of scandium was ran in-line with the samples and standards to serve as an internal standard. The emission wavelength 251.611 nm was used for Si analysis.

Si (mg/L) of the unknown samples was calculated based on the calibration curve. The Si concentration (mg/L) was converted to SiO₂ (mg/L) based on the mass fraction of Si 47% by weight in SiO₂. Values generated are shown below in Table 1.

### Particle Analysis by Dynamic Light Scattering (DLS)

All DLS measurements were performed using a Microtrac Nanotrac Flex In-situ Analyzer, available from Mircrotrac, INC, Montgomeryville Pa. Based on 1800 heterodyne dynamic light scattering the Nanotrac Flex can measure up to 40% w/v material concentration. This instrument measures particles ranging in size from 0.8 to 6,500 nanometers. All samples were measured as is without any dilutions.

### Particle Analysis by Scanning Mobility Particle Sizer (SMPS)

The original CMP slurry, the effluent, and the retentive fluids for Examples 1 and 2 were analyzed by SMPS. They were sonicated at room temperature for 5 minutes and mixed on a vortex for 1 minute before being sampled. The solutions were then diluted to 50 mL with MilliQ water (>18 MΩ·cm). The dilution factors are 200, by volume for the effluents of Examples 1 and 2, and 1000, by volume for the original and retentive slurries. After being sonicated for 5 minutes, the diluted samples were analyzed by SMPS following the procedure below.

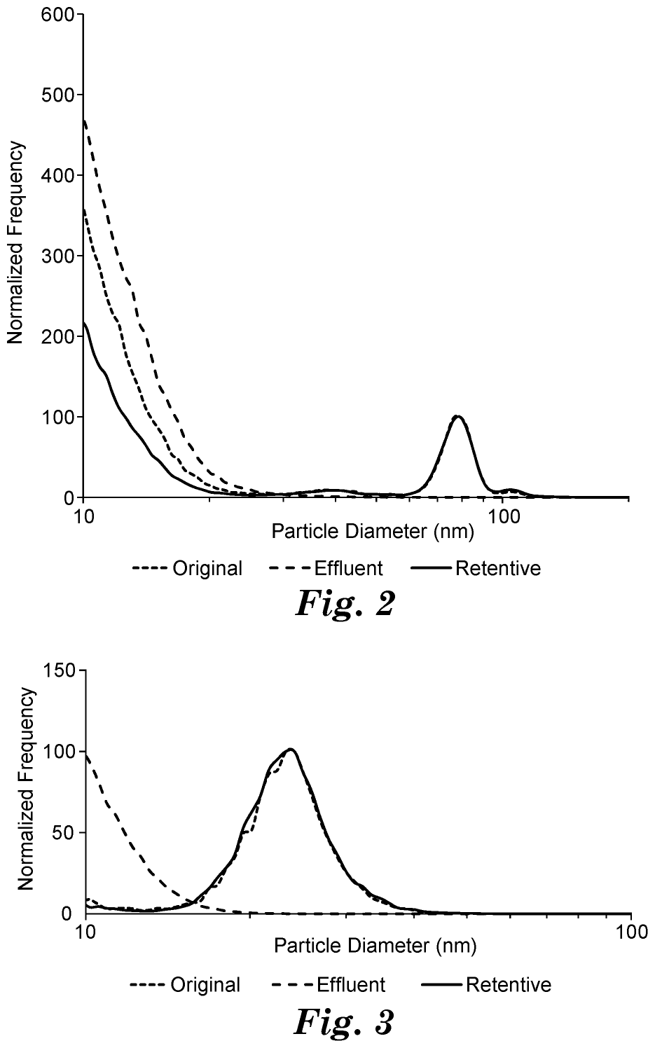

The SMPS instrument included a TSI 3485 Liquid Nanoparticle Nebulizer coupled to a dynamic mobility analyzer (DMA) TSI 3080 Electrostatic Classifier and a TSI 3788 Nano Water-Based Condensation Particle Counter (CPC), all from TSI Incorporated at Shoreview, Minn. TSI Aerosol Instrument Manager Software was used to collect the data. The SMPS system was calibrated using a reference material solution provided by TSI Incorporated and contained 4.4×10¹³ particles/mL of 28 nm SiO₂ particles suspended in an aqueous solution. The samples were placed in the pressurized sampling chamber of the nebulizer and sprayed through a capillary. The sample flow rate was 0.5 mL/min, and the dilution ratio was 100:1, by volume. The dried aerosol then passes to the DMA where the voltage is ramped from −11 V to −9.7 kV. The sheath flow in the DMA was set at 15 L/min. The diameter of silica was characterized by electrical mobility, which is inversely proportional to the projected area of the particle. Once sized, the particles traveled to the CPC where they were counted. FIG. 2 is a graph showing the diameter and frequency of the particles of Example 1 and FIG. 3 is a graph showing the diameter and frequency of the particles of Example 2.

### Removing Fine Particles from the Chemical Mechanical Planarization (CMP) Slurry

### Example 1

A colloidal silica CMP Slurry 79, having the mean particle size measured using DLS, was filtered through a 3M UFPT module. The UFPT module has the same general configuration and uses the same semi-permeable fiber membrane of a 3M LIQUI-FLUX Membrane Module UF-PES Series, Type W05-08A, available form 3M Company, St. Paul Minn. The UFPT module includes only 10 of the porous hollow fibers that are used in the larger UF-PES W05-08A module. The above slurry was pumped at 100 ml/min using a peristaltic pump with Viton tubing. The retentive, defined as the fluid that did not go through the porous wall of the hollow fiber, was collected as well as the effluent, defined as the fluid that passed through the porous wall of the hollow fiber. The original CMP slurry, the effluent, and the retentive fluids were subjected to inductively coupled plasma atomic emission spectroscopy (ICP-AES) and Scanning Mobility Particle Sizer (SMPS) analysis.

### Example 2

A colloidal silica CMP Slurry 24, having the mean particle size of 24 nm, measured using Dynamic Light Scattering (DLS), was filtered through a 3M UFPT module. The UFPT module included 10 porous hollow fibers that are used in larger modules of UF-PES Series such as W20-08A, W10-08A, and W05-08A. The above slurry was pumped at 100 ml/min using a peristaltic pump with Viton tubing. The retentive, defined as the fluid that did not go through the porous wall of the hollow fiber, was collected as well as the effluent, defined as the fluid that passed through the porous wall of the hollow fiber. The original CMP slurry, the effluent, and the retentive fluids were subjected to ICP-AES and SMPS analysis.

TABLE 1
Concentration of SiO₂ in Examples 1 and 2.

| | SiO₂ Original slurry | SiO₂ Effluent | SiO₂ Retentive |
|---|---|---|---|
| | (mg/L) | (mg/L) | (mg/L) |
| Example 1 | 2.40 × 10⁵ | 402 | 4.42 × 10⁵ |
| Example 2 | 3.57 × 10⁴ | 85 | 6.38 × 10⁴ |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a method of making a particulate slurry, the method comprising:
contacting a particulate slurry precursor including a carrier and a plurality of abrasive particles with a semi-permeable fiber membrane;
separating the particulate slurry precursor into a concentrate and an effluent, wherein
the concentrate comprises the particulate slurry;
the effluent comprises the carrier and a plurality of particles disposed in the carrier, the particles of the effluent having a median size that is less than a median size of the abrasive particles of the concentrate; and
a pressure difference measured between an inlet to which the particulate slurry precursor is supplied and a first outlet to which the effluent is supplied is in a range of from about 1 psi to about 15 psi.

Embodiment 2 provides the method of Embodiment 1, further comprising recirculating the concentrate at least once.

Embodiment 3 provides the method of any one of Embodiments 1 or 2, wherein a majority of the particles of the effluent have a median size that is less than or equal to about 10 nm.

Embodiment 4 provides the method of any one of Embodiments 1-3, wherein a majority of the particles of the effluent have a median size that is less than or equal to about 20 nm.

Embodiment 5 provides the method of any one of Embodiments 1-4, wherein the particulate slurry precursor is pumped or vacuumed through a fiber of the semi-permeable fiber membrane at a rate in a range of from about 0.5 ml/min to about 150 ml/min.

Embodiment 6 provides the method of any one of Embodiments 1-5, wherein the particulate slurry precursor is pumped or vacuumed through a fiber of the semi-permeable fiber membrane at a rate in a range of from about 1.2 ml/min to about 2.3 ml/min.

Embodiment 7 provides the method of any one of Embodiments 1-6, wherein the pressure difference between the inlet and the first outlet is in a range of from about 1 psi to about 10 psi.

Embodiment 8 provides the method of any one of Embodiments 1-7, wherein the pressure difference between the inlet and the first outlet is in a range of from about 2 psi to about 4 psi.

Embodiment 9 provides the method of any one of Embodiments 1-8, wherein the pressure difference between the inlet and the first outlet is about 3 psi.

Embodiment 10 provides the method of any one of Embodiments 1-9, wherein a greater amount of the particulate slurry precursor passes through the second outlet as the concentrate than through a first outlet as the effluent.

Embodiment 11 provides the method of Embodiment 10, wherein an amount of the particulate slurry precursor particles that exists in the system as the concentrate is in a range of from about 5% to about 90% greater by weight than an amount that exists as the effluent.

Embodiment 12 provides the method of any one of Embodiments 10 or 11, wherein the amount of the particulate slurry particles that exists in the system as the concentrate is in a range of from about 50% to about 80% greater than the amount that exists the effluent.

Embodiment 13 provides the method of any one of Embodiments 1-12, wherein the first outlet is free of a restriction.

Embodiment 14 provides a system for producing a particulate slurry, the system comprising:
a semi-permeable fiber membrane;
a particulate slurry precursor in contact with the semi-permeable fiber membrane, the particulate precursor slurry including a carrier and a plurality of abrasive particles; and
a case that at least partially contains the semi-permeable fiber membrane, the case comprising:
   an inlet feeding into the case;
   a first outlet; and
   a second outlet,
a recirculation line attached to the second outlet and in fluid communication with the inlet,
wherein the system is configured to create a pressure difference measured between the inlet and the first outlet in a range of from about 1 psi to about 15 psi.

Embodiment 15 provides the system of Embodiment 14, wherein the semi-permeable fiber membrane comprises a hollow fiber.

Embodiment 16 provides the system of any one of Embodiments 14 or 15, further comprising a pump positioned upstream or downstream of the inlet.

Embodiment 17 provides the system of any one of Embodiments 14-16, wherein the semi-permeable fiber membrane comprises:
a hydrophobic aromatic sulfone polymer; and
a hydrophilic polymer.

Embodiment 18 provides the system of Embodiment 17, wherein the hydrophobic polymer comprises a hydrophobic aromatic sulfone polymer.

Embodiment 19 provides the system of Embodiment 18, wherein the hydrophobic aromatic sulfone polymer is a sulfonated aromatic sulfone polymer.

Embodiment 20 provides the system of any one of Embodiments 18 or 19, wherein the hydrophobic aromatic sulfone polymer is a polysulfone, polyether sulfone, or a copolymer thereof.

Embodiment 21 provides the system of any one of Embodiments 17-20, wherein the hydrophilic polymer has a weight average molecular weight of more than 10,000 Daltons.

Embodiment 22 provides the system of any one of Embodiments 17-20, wherein the hydrophilic polymer comprises a polyvinylpyrrolidone, a polyethylene glycol, a polyvinylpyrrolidone, a polyethylene glycol and a hydrophilically modified aromatic sulfone polymer, or a mixture thereof.

Embodiment 23 provides the system of any one of Embodiments 14-22, wherein the semi-permeable fiber membrane comprises an inner surface, an outer surface facing outwards and an intermediate wall having a wall thickness, wherein in the inner surface the fiber membrane has an open-pore separating layer, adjoining a separating layer proximate to the outer surface and adjoining the supporting layer.

Embodiment 24 provides the system of any one of Embodiment 23, wherein pores of the separating layer have an average size in a range of from about 5 μm to about 100 μm.

Embodiment 25 provides the system of any one of Embodiments 23 or 24, wherein pores of the separating layer have an average size in a range of from about 10 μm to about 50 μm.

Embodiment 26 provides the system of any one of Embodiments 23-25, wherein at least a portion of the pores are through pores.

Embodiment 27 provides the system of any one of Embodiments 14-26, wherein the semi-permeable fiber membrane comprises one or more hollow fibers having an inner diameter in a range of from about 0.5 μm to about 2 mm.

Embodiment 28 provides the system of any one of Embodiments 14-27, wherein the semi-permeable fiber membrane comprises one or more fibers having a diameter in a range of from about 0.75 μm to about 1.2 μm.

Embodiment 29 provides the system of any one of Embodiments 14-28, wherein the semi-permeable fiber membrane comprises at least 5 fibers.

Embodiment 30 provides the system of any one of Embodiments 14-29, wherein the semi-permeable fiber membrane comprises 5 to 100,000 fibers.

Embodiment 31 provides the system of any one of Embodiments 14-30, the first outlet is free of a restriction device.

Embodiment 32 provides the system of any one of Embodiments 14-31, wherein the first outlet is unrestricted.

Embodiment 33 provides the system of any one of Embodiments 14-32, wherein the carrier comprises an aqueous solution or an organic solution.

Embodiment 34 provides the system of Embodiment 33, wherein the aqueous solution includes from about 90 wt % to about 100 wt % water.

Embodiment 35 provides the system of any one of Embodiments 33 or 34, wherein the organic solution comprises a substituted or unsubstituted (C₁-C₂₀)hydrocarbyl.

Embodiment 36 provides the system of any one of Embodiments 14-35, wherein the abrasive particles individually comprise a substantially spherical morphology.

Embodiment 37 provides the system of any one of Embodiments 14-36, wherein an aspect ratio of the individual abrasive particles is in a range of from about 1 to about 2.

Embodiment 38 provides the system of Embodiments 14-37, wherein an aspect ratio of the individual abrasive particles is in a range of from about 1.0 to about 1.5.

Embodiment 39 provides the system of any one of Embodiments 14-38, wherein an aspect ratio of the individual abrasive particles is about 1.

Embodiment 40 provides the system of any one of Embodiments 14-39, wherein the abrasive particles comprise an inorganic material an organic material, or a mixture thereof.

Embodiment 41 provides the system of Embodiment 40, wherein the inorganic material comprises an elemental metal, a metal alloy, a metal oxide, a ceramic, or a mixture thereof.

Embodiment 42 provides the system of any one of Embodiments 40 or 41 wherein the inorganic material comprises alumina, silica, ceria, a silicon nitride, a glass, an alumina-phosphorous pentoxide, an alumina-boria-silica, a zirconia, a zirconia-alumina, a zirconia-silica, an aluminum oxide, a heat-treated aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 43 provides the system of any one of Embodiments 40-42, wherein the organic material comprises a reaction product of a polymerizable mixture including one or more polymerizable resins.

Embodiment 44 provides the system of Embodiment 43, wherein the one or more polymerizable resins are a phenolic resin, a urea formaldehyde resin, a urethane resin, a melamine resin, an epoxy resin, a bismaleimide resin, a vinyl ether resin, an aminoplast resin, an acrylate resin, an acrylated isocyanurate resin, an isocyanurate resin, an acrylated urethane resin, an acrylated epoxy resin, an alkyd resin, a polyester resin, a dying oil, or a mixture thereof.

Embodiment 45 provides the system of any one of Embodiments 43 or 44, wherein the polymerizable mixture further comprises at least one of a plasticizer, an acid catalyst, a cross-linker, a surfactant, a mild abrasive, a pigment, a catalyst, and an antibacterial agent.

Embodiment 46 provides the system of any one of Embodiments 14-45, wherein a Mohs hardness value of the abrasive particles, individually, is in a range of from about 4 to about 10.

Embodiment 47 provides the system of any one of Embodiments 14-46, wherein a Mohs hardness value of the abrasive particles, individually, is in a range of from about 5 to about 9.

Embodiment 48 provides the system of any one of Embodiments 14-47, the particulate slurry further comprising a surfactant, an oxidizer, an inhibitor, a passivator, a chelator, or a mixture thereof.

Embodiment 49 provides a particulate slurry comprising:
a carrier; and
a plurality of abrasive particles disposed in the carrier, the plurality of abrasive particles having a size distribution curve substantially conforming to a positively skewed distribution curve relative to a normal distribution curve, wherein a majority of the abrasive particles have a median size of at least 20 nm.

Embodiment 50 provides the particulate slurry of Embodiment 49, wherein a majority of the abrasive particles have a median size of at least 30 nm.

Embodiment 51 provides the particulate slurry of any one of Embodiments 49 or 50, wherein a majority of the abrasive particles have a median size in a range of from about 20 nm to about 100 nm.

Embodiment 52 provides the particulate slurry of any one of Embodiments 49-51, wherein a majority of the abrasive particles have a median size in a range of from about 30 nm to about 90 nm.

Embodiment 53 provides the particulate slurry of any one of Embodiments 49-52, wherein the chemical planarization slurry is substantially free of any abrasive particles having a median size of about 20 nm or less.

Embodiment 54 provides the particulate slurry of any one of Embodiments 49-53, wherein the chemical planarization slurry is substantially free of any abrasive particles having a median size of about 10 nm or less.

Embodiment 55 provides the particulate slurry of any one of Embodiments 49-54, wherein the chemical planarization slurry is substantially free of any abrasive particles having a median size in a range of from about 1 nm to about 20 nm.

Embodiment 56 provides the particulate slurry of any one of Embodiments 49-55, wherein the chemical planarization slurry is substantially free of any abrasive particles having a median size in a range of from about 5 nm to about 15 nm.

Embodiment 57 provides the particulate slurry of any one of Embodiments 49-56, wherein the carrier comprises an aqueous solution or an organic solution.

Embodiment 58 provides the particulate slurry of Embodiment 57, wherein the aqueous solution includes from about 90 wt % to about 100 wt % water.

Embodiment 59 provides the particulate slurry of any one of Embodiments 57 or 58, wherein the organic solution comprises a substituted or unsubstituted (C₁-C₂₀)hydrocarbyl.

Embodiment 60 provides the particulate slurry of any one of Embodiments 49-59, wherein the abrasive particles individually comprise a substantially spherical morphology.

Embodiment 61 provides the particulate slurry of any one of Embodiments 49-60, wherein an aspect ratio of the individual abrasive particles is in a range of from about 1 to about 2.

Embodiment 62 provides the particulate slurry of Embodiments 49-61, wherein an aspect ratio of the individual abrasive particles is in a range of from about 1.0 to about 1.5.

Embodiment 63 provides the particulate slurry of any one of Embodiments 49-62, wherein an aspect ratio of the individual abrasive particles is about 1.

Embodiment 64 provides the particulate slurry of any one of Embodiments 49-63, wherein the abrasive particles comprise an inorganic material an organic material, or a mixture thereof.

Embodiment 65 provides the particulate slurry of Embodiment 64, wherein the inorganic material comprises an elemental metal, a metal alloy, a metal oxide, a ceramic, or a mixture thereof.

Embodiment 66 provides the particulate slurry of any one of Embodiments 64 or 65 wherein the inorganic material comprises alumina, silica, ceria, a silicon nitride, a glass, an alumina-phosphorous pentoxide, an alumina-boria-silica, a zirconia, a zirconia-alumina, a zirconia-silica, an aluminum oxide, a heat-treated aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 67 provides the particulate slurry of any one of Embodiments 64-66, wherein the organic material comprises a reaction product of a polymerizable mixture including one or more polymerizable resins.

Embodiment 68 provides the particulate slurry of Embodiment 67, wherein the one or more polymerizable resins are a phenolic resin, a urea formaldehyde resin, a urethane resin, a melamine resin, an epoxy resin, a bismaleimide resin, a vinyl ether resin, an aminoplast resin, an acrylate resin, an acrylated isocyanurate resin, an isocyanurate resin, an acrylated urethane resin, an acrylated epoxy resin, an alkyd resin, a polyester resin, a dying oil, or a mixture thereof.

Embodiment 69 provides the particulate slurry of any one of Embodiments 49-68, wherein a Mohs hardness value of the abrasive particles, individually, is in a range of from about 4 to about 10.

Embodiment 70 provides the particulate slurry of any one of Embodiments 49-69, wherein a Mohs hardness value of the abrasive particles, individually, is in a range of from about 5 to about 9.

Embodiment 71 provides the particulate slurry of any one of Embodiments 49-70, further comprising a surfactant, an oxidizer, an inhibitor, a passivator, a chelator, or a mixture thereof.

Embodiment 72 provides the particulate slurry of any one of Embodiments 49-71, wherein the chemical mechanical planarization slurry is a particulate slurry.

1. A method of making a particulate slurry, the method comprising:
contacting a particulate slurry precursor including a carrier and a plurality of abrasive particles with a semi-permeable fiber membrane;
separating the particulate slurry precursor into a concentrate and an effluent, wherein
the concentrate comprises the particulate slurry;
the effluent comprises the carrier and a plurality of particles disposed in the carrier, the particles of the effluent having a median size that is less than a median size of the abrasive particles of the concentrate; and
a pressure difference measured between an inlet to which the particulate slurry precursor is supplied and a first outlet to which the effluent is supplied is in a range of from about 1 psi to about 15 psi.

2. The method of claim 1, further comprising recirculating the concentrate at least once.

3. The method of claim 1, wherein a majority of the particles of the effluent have a median size that is less than or equal to about 20 nm.

4. The method of claim 3, wherein a majority of the particles of the effluent have a median size that is less than or equal to about 10 nm.

5. The method of claim 1, wherein the pressure difference between the inlet and the first outlet is in a range of from about 1 psi to about 10 psi.

6. The method of claim 5, wherein the pressure difference between the inlet and the first outlet is in a range of from about 2 psi to about 4 psi.

7. The method of claim 1, wherein a greater amount of the particulate slurry precursor passes through a second outlet as the concentrate than through a first outlet as the effluent.

8. The method of claim 1, wherein the first outlet is free of a restriction.

9. A system for producing a particulate slurry, the system comprising:
a semi-permeable fiber membrane;
a particulate slurry precursor in contact with the semi-permeable fiber membrane, the particulate precursor slurry including a carrier and a plurality of abrasive particles; and
a case that at least partially contains the semi-permeable fiber membrane, the case comprising:
an inlet feeding into the case;
a first outlet; and
a second outlet,
a recirculation line attached to the second outlet and in fluid communication with the inlet,
wherein the system is configured to create a pressure difference measured between the inlet and the first outlet in a range of from about 1 psi to about 15 psi.

10. The system of claim 9, wherein the semi-permeable fiber membrane comprises a hollow fiber.

11. The system of claim 9, wherein the semi-permeable fiber membrane comprises:
a hydrophobic aromatic sulfone polymer; and
a hydrophilic polymer.

12. The system of claim 9, wherein the semi-permeable fiber membrane comprises an inner surface, an outer surface facing outwards and an intermediate wall having a wall thickness, wherein in the inner surface the fiber membrane has an open-pore separating layer, adjoining a separating layer proximate to the outer surface and adjoining a supporting layer.

13. The system of claim 12, wherein pores of the separating layer have an average size in a range of from about 5 μm to about 100 μm.

14. The system of claim 13, wherein pores of the separating layer have an average size in a range of from about 10 μm to about 50 μm.

15. The system of claim 9, wherein the semi-permeable fiber membrane comprises one or more hollow fibers having an inner diameter in a range of from about 0.5 μm to about 2 mm.

16. A particulate slurry comprising:
a carrier; and
a plurality of abrasive particles disposed in the carrier, the plurality of abrasive particles having a size distribution curve substantially conforming to a positively skewed distribution curve relative to a normal distribution curve, wherein a majority of the abrasive particles have a median size of at least 20 nm.

17. The particulate slurry of claim 16, wherein a majority of the abrasive particles have a median size in a range of from about 20 nm to about 100 nm.

18. The particulate slurry of claim 16, wherein the abrasive particles individually comprise a substantially spherical morphology.

19. The particulate slurry of claim 16, wherein the abrasive particles comprise an inorganic material, an organic material, or a mixture thereof.

20. The particulate slurry of claim 19, wherein the inorganic material comprises alumina, silica, ceria, a silicon nitride, a glass, an alumina-phosphorous pentoxide, an alumina-boria-silica, a zirconia, a zirconia-alumina, a zirconia-silica, an aluminum oxide, a heat-treated aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.
